(19) United States
(12) Patent Application Publication
(10) Pub. No.: US 2021/0129626 A1
(43) Pub. Date: May 6, 2021

(54) HVAC SYSTEM INCLUDING TWO-LAYER AIRFLOW COOLING MODE

(71) Applicant: DENSO International America, Inc., Southfield, MI (US)

(72) Inventor: Tom PEARD, Birmingham, MI (US)

(21) Appl. No.: 16/672,886

(22) Filed: Nov. 4, 2019

(51) Int. Cl. B60H 1/00; B60H 1/32

(52) U.S. Cl. CPC B60H 1/00849; B60H 1/3213

(57) ABSTRACT

A heating, ventilation, and air conditioning (HVAC) system for a cabin of a vehicle. The HVAC system includes a control module configured to operate the HVAC system in a two-layer airflow cooling mode by: operating a blower unit to draw the inside air and the outside air into the blower unit, and blow the inside air and the outside air through the blower unit into an air conditioning unit; and operating the air conditioning unit to cool the inside air and the outside air, and direct the cooled inside air and the cooled outside air out of the air conditioning unit through only the face opening portion.

### FIELD

The present disclosure relates to a heating, ventilation, and air condition (HVAC) system including a two-layer airflow cooling mode.

### BACKGROUND

This section provides background information related to the present disclosure, which is not necessarily prior art.

During the summer, or whenever ambient air temperature is very warm, a heating, ventilation, and air conditioning (HVAC) system typically expends maximum energy to cool an area. For example, to cool a passenger cabin of a vehicle that has been parked in the warm summer sun for an extended period of time, the vehicle's HVAC system requires maximum energy, which typically reduces the overall efficiency of the HVAC system and reduces fuel economy of the vehicle. An improved HVAC system that increases fuel economy by operating more efficiency during summer conditions when maximum cooling is called for would thus be desirable.

### SUMMARY

This section provides a general summary of the disclosure, and is not a comprehensive disclosure of its full scope or all of its features.

The present disclosure provides for a heating, ventilation, and air conditioning (HVAC) system for a cabin of a vehicle. The HVAC system includes a control module configured to operate the HVAC system in a two-layer airflow cooling mode by: operating a blower unit to draw the inside air and the outside air into the blower unit and blow the inside air and the outside air through the blower unit into an air conditioning unit; and operating the air conditioning unit to cool the inside air and the outside air, and direct the cooled inside air and the cooled outside air out of the air conditioning unit through only a face opening portion.

The present disclosure further provides for a method of operating a heating, ventilation, and air conditioning (HVAC) system for a cabin of a vehicle. The method includes operating a blower unit of the HVAC system in a two-layer airflow cooling mode with a control module of the HVAC system to draw inside air from the cabin into the blower unit through a first inside air inlet port, draw outside air into the blower unit through an outside air inlet port, and blow the inside air and the outside air through the blower unit into an air conditioning unit of the HVAC system. The method further includes operating the air conditioning unit in the two-layer airflow cooling mode with the control module to cool the inside air and the outside air with an evaporator, and direct the inside air and the outside air that has been cooled out of the air conditioning unit through only a face opening portion configured to be in communication with a face outlet of the cabin.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a cross-sectional view of an exemplary blower unit of a heating, ventilation, and air conditioning (HVAC) system in accordance with the present disclosure;

FIG. 2 is a cross-sectional view of an exemplary air conditioning unit of the HVAC system of the present disclosure;

FIG. 3 illustrates an exemplary control module in accordance with the present disclosure; and

FIG. 4 illustrates an exemplary operational algorithm of the control module for operating the HVAC system in various modes, including a two-layer airflow cooling mode in accordance with the present disclosure.

Corresponding reference numerals indicate corresponding parts throughout the several views of the drawings.

### DETAILED DESCRIPTION

Example embodiments will now be described more fully with reference to the accompanying drawings.

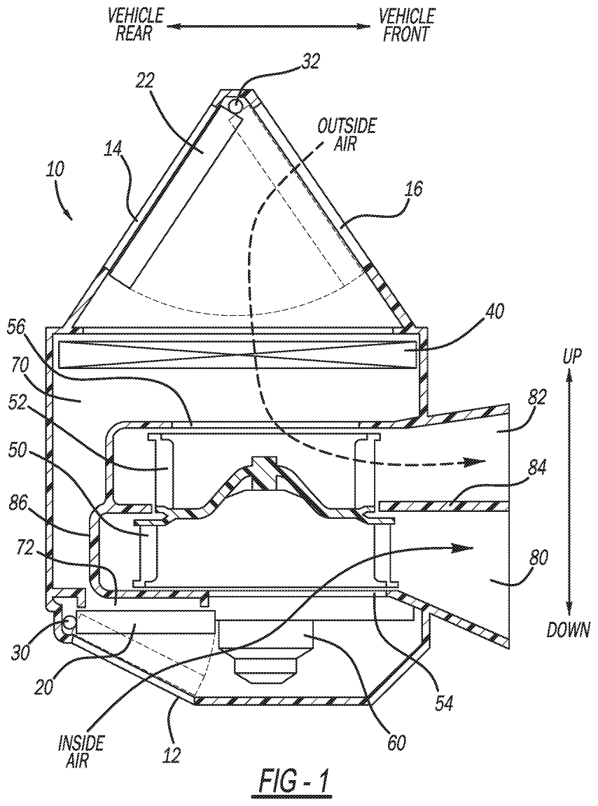

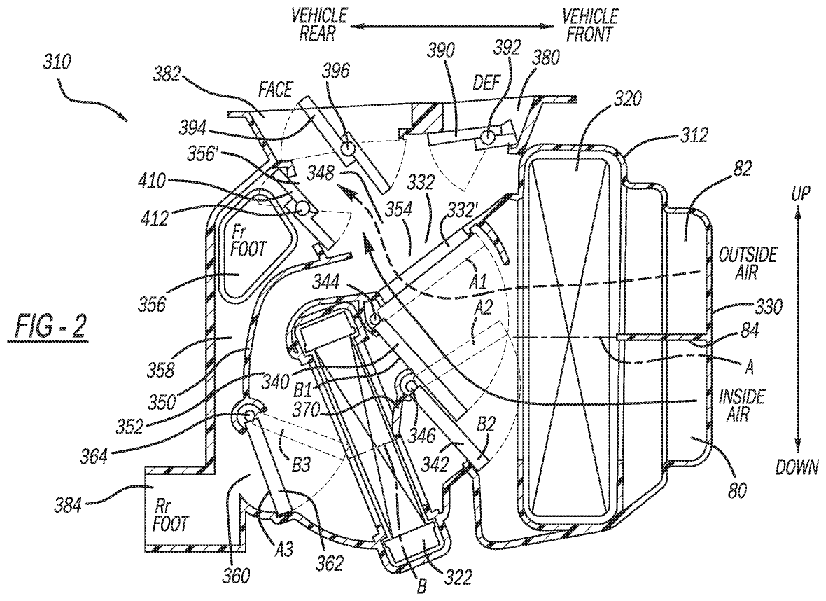

The present disclosure is directed to a heating, ventilation, and air conditioning (HVAC) system generally including a blower unit 10 (FIG. 1) and an air conditioning unit 310 (FIG. 2). The HVAC system is configured for use in any suitable vehicle, such as any suitable passenger vehicle, mass transit vehicle, recreational vehicle, construction vehicle, construction equipment, military vehicle, watercraft, aircraft, etc. The HVAC system of the present disclosure may also be configured for use with any suitable non-vehicular application, such as to condition the air of any suitable building or structure.

When the HVAC system is configured as a vehicular HVAC system, the air conditioning unit 310 may be disposed under an instrument panel in a passenger compartment at an approximate center portion in a left-right (side-to-side) direction of the vehicle. The blower unit 10 may be disposed under the instrument panel on a side of the air conditioning unit 310 in the left-right (side-to-side) direction. The blower unit 10 may be disposed at a front passenger's seat side next to a driver's seat, for example.

With particular reference to FIG. 1, the blower unit 10 will now be described in additional detail. The blower unit 10 includes a first inside air inlet port 12 and a second inside air inlet port 14 through which inside air (i.e., air from inside a passenger cabin of the vehicle) flows into the blower unit 10. The blower unit 10 further includes an outside air inlet port 16 through which outside air (i.e., air from outside of the vehicle) flows into the blower unit 10. The first inside air inlet port 12 is at a lower portion of the blower unit 10, and is opened and closed by a first inside/outside air switching door 20. The outside air inlet port 16 and the second inside air inlet port 14 are at an upper portion of the blower unit 10, and are opened and closed by a second inside/outside air switching door 22.

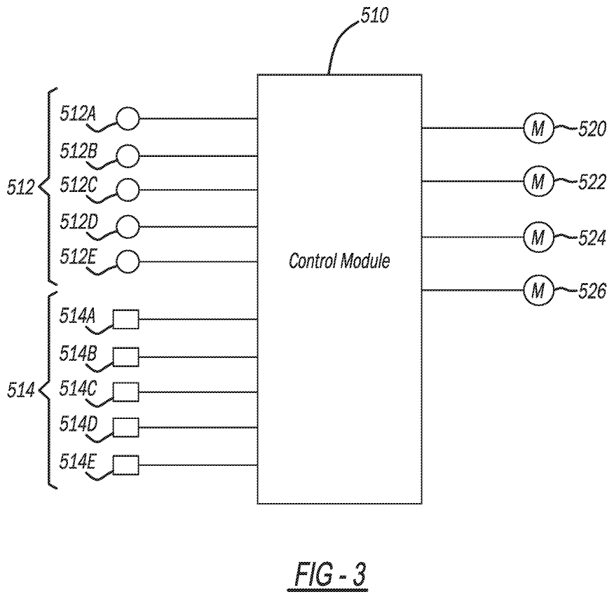

The first inside/outside air switching door 20 is rotated about a first rotary shaft 30. The second inside/outside air switching door 22 is rotated about a second rotary shaft 32. The first and the second inside/outside air switching doors 20 and 22 may be plate-like doors, or any other suitable airflow control members. The first and second inside/outside air switching doors 20 and 22 may be opened and closed in any suitable manner. For example, the first and second inside/outside air switching doors 20 and 22 may be operatively linked and rotated by any suitable actuator, such as a servomotor through a link mechanism, based on control signals from a control module 510 (see FIG. 3) of the air conditioning system.

The blower unit 10 further includes any suitable air filter 40 for filtering air flowing into the blower unit 10 through the second inside air inlet port 14 or the outside air inlet port 16. A first fan (inside air side) 50 and a second fan (outside air side) 52 are on a side of the air filter 40 opposite to the air inlet ports 14 and 16. Thus, the first fan 50 and the second fan 52 are disposed on a lower side of the air filter 40 in an up-down direction as illustrated in FIG. 1. The first fan 50 and the second fan 52 blow air that has entered the blower unit 10 through the inlet ports 12, 14, and 16. The first and second fans 50 and 52 blow the air out of the blower unit 10 and into the air conditioning unit 310 through first air passage 80 and second air passage 82 (see FIG. 1 and FIG. 2).

The first fan 50 and the second fan 52 may be any suitable airflow generation devices. For example, the first fan 50 and the second fan 52 may be centrifugal multi-blade fans (e.g., sirocco fans) rotated simultaneously by a single common electric motor 60, or configured and rotated in any other suitable manner. The electric motor 60 may be at any suitable location within, or outside of, the blower unit 10. For example and as illustrated in FIG. 1, the electric motor 60 is disposed at a lower side of the first fan 50 (relative to the up-down direction of FIG. 1). The first fan 50 has a first suction port 54 in fluid communication with the first inside air inlet port 12. The first suction port 54 of the first fan 50 communicates with an area 70 at a downstream side of the air filter 40 through a communication path 72. The first inside/outside air switching door 20 also opens and closes the communication path 72 while opening and closing the first inside air inlet port 12.

FIGS. 1 and 2 illustrate an exemplary two-layer airflow cooling mode of the HVAC system, which is described further herein. During the two-layer airflow cooling mode, because the first inside/outside air switching door 20 opens the first inside air inlet port 12 and closes the communication path 72 communicating with the outside air inlet port 16, inside air is drawn into the first suction port 54 of the first fan 50. On the other hand, because the second inside/outside air switching door 22 closes the second inside air inlet port 14 and opens the outside air inlet port 16, outside air is sucked into a second suction port 56 of the second fan 52. Therefore, in the two-layer airflow mode the first fan 50 blows inside air from the inside air inlet port 12 into the first air passage 80, and the second fan 52 blows outside air from the outside air inlet port 16 into the second air passage 82. The first air passage 80 and the second air passage 82 are partitioned by a partition plate 84 disposed between the first fan 50 and the second fan 52. The partition plate 84 may be formed integrally with a scroll casing 86 made of resin, for accommodating both the first and second fans 50 and 52.

With particular reference to FIG. 2, the air conditioning unit 310 will be described in additional detail. The air conditioning unit 310 includes a case 312. Seated within the case 312 is an evaporator (i.e., cooling heat exchanger) 320 and a heater core (i.e., heating heat exchanger). The case 312 defines an air inlet 330 that is in fluid communication with the first air passage 80 and the second air passage 82 of the blower unit 10. Thus, airflow generated by the blower unit 10 enters the case 312 of the air conditioning unit 310 through the air inlet 330.

The evaporator 320 is arranged proximate to the air inlet 330. The evaporator 320 extends entirely across the air inlet 330, and across the adjacent first and second air passages 80 and 82. The evaporator 320 is configured to cool air flowing across the evaporator 320, as is known in the art. As illustrated in FIG. 2, the evaporator 320 is thin in the front-rear direction of the vehicle and is disposed in the air conditioning case 312 in such a manner that a longitudinal direction thereof extends in the up-down direction of the vehicle. A partition plate 84 partitions the air passage extending from the air inlet 330 to the evaporator 320 into the first air passage 80 at a lower side of the vehicle and the second air passage 82 at an upper side of the vehicle. The partition plate 84 extends in a generally horizontally direction relative to the front-rear direction and the left-right direction of the vehicle. The partition plate 84 can be formed in any suitable manner, such as integrally formed with the air conditioning case 312. The partition plate 84 may alternatively be formed separately from the air conditioning case 312, and connected to the air conditioning case 312 in any suitable manner.

The evaporator 320 is spaced apart from the heater core 322 to define a gap therebetween. The heater core 322 heats air that has passed through the evaporator 320. High-temperature cooling water (hot water) for cooling an engine of the vehicle flows through the heater core 322. The heater core 322 uses the cooling water as a heat source to heat the air. Similar to the evaporator 320, the heater core 322 is thin in the front-rear direction of the vehicle, and is disposed in the air conditioning case 312 so that a longitudinal direction of the heater core 322 is in the up-down direction of the vehicle. In the example illustrated, the heater core 322 is slightly inclined toward a vehicle rear side by a small angle. The heater core 322 is disposed in the air conditioning case 312 to form a cool air bypass passage 332 at an upper side of the heater core 322. Air having passed through the evaporator 320 bypasses the heater core 322 by way of the cool air bypass passage 332.

The air conditioning unit 310 further includes a first air-mixing door 340 and a second air-mixing door 342 for adjusting a volume of air passing through the heater core 322 and a volume of air bypassing the heater core 322. Although two air-mixing doors are illustrated, any suitable number of air-mixing doors may be included, such as one or more than two. The first and second air-mixing doors 340 and 342 are between the heater core 322 and the evaporator 320 within the air conditioning case 312. The first air-mixing door 340 is connected to, and rotated by, a first rotary shaft 344. The second air-mixing door 342 is connected to, and rotated by, a second rotary shaft 346. The first and second air-mixing doors 340 and 342 are generally rotated in an up-down direction with respect to the orientation of FIG. 2. Each one of the first and second rotary shafts 344 and 346 have an end protruding out from within the air conditioning case 312, which is connected to an actuator such as a servomotor through a link mechanism. The first and second air-mixing doors 340 and 342 are operatively linked and are rotated according to temperature control signals from the electronic control module 510 of the air conditioning system.

During a maximum cooling (MC) mode of the air conditioning unit 310, the first and second air-mixing doors 340 and 342 are rotated to positions B1 and B2 respectively in FIG. 2 to close an air inlet of the heater core 322. On the other hand, during a maximum heat (MH) mode, the first and second air mixing doors 340 and 342 are rotated to positions A1 and A2 respectively in FIG. 2. Therefore, the first air-mixing door 340 closes an inlet hole 332′ of the cool air bypass passage 332, and a top end of the second air-mixing door 342 is disposed at a position immediately after the evaporator 320 to be proximate to an extending line A of the partition plate 84. During the maximum heating mode the second air-mixing door 342 is used as a movable partition member for partitioning an air passage between the evaporator 320 and the heater core 322 into the first air passage 80 and the second air passage 82.

A partition wall 350 of the case 312 is spaced apart from the heater core 322 at a downstream side of the heater core 322. The partition wall 350 extends in an up-down direction (as illustrated in FIG. 2), and partially defines a first warm air passage 352 extending from the heater core 322 in an upward direction. A downstream side (an upper side) of the first warm air passage 352 joins with the cool air bypass passage 332 in an air-mixing chamber 354 proximate to an upper side of the heater core 322. A warm air bypass inlet 360 is at a lower end (i.e., upstream end) of the partition wall 350 and opposite to a downstream surface of the heater core 322.

The warm air bypass inlet 360 is opened and closed by a warm air bypass door 362. The warm air bypass door 362 is connected to a rotary shaft 364, which is rotatably held in the air conditioning case 312 at an upper end portion of the warm air bypass inlet 360. The warm air bypass door 362 is rotated around the rotary shaft 364 between open position B3 and closed position A3. The warm air bypass door 362 is rotated by any suitable actuator, such as the same actuator that drives the first and second air-mixing doors 340 and 342, through a link mechanism that is operatively linked with the both air-mixing doors 340 and 342.

When the air conditioning unit 310 is set to a two-layer airflow heating mode, the warm air bypass door 362 is rotated to position B3 of FIG. 2 (i.e., at a position proximate to a partition line B of the heater core 322) so that the first warm air passage 352 at a position immediately after the heater core 322 is also partitioned into the first air passage 80 and the second air passage 82. That is, the warm air bypass door 362 is used as a movable partition member for partitioning the air passage at an immediately downstream side of the heater core 322 into two air passages corresponding to the first and second air passages 80 and 82. Therefore, when in position B3 the partition wall 350 acts as a stationary partition member for partitioning the first and second air passages 80 and 82 from each other. A stationary partition plate 370 is disposed between an upstream surface of the partition line B and the second rotary shaft 346 of the second air-mixing door 342, and is formed integrally with the air conditioning case 312.

A defroster opening portion 380 is provided on an upper wall portion of the air conditioning case 312 at a vehicle front side. Conditioned air from the air-mixing chamber 354 flows into the defroster opening portion 380, and is blown toward an inner surface of a windshield of the vehicle from a defroster air outlet through a defroster duct. The defroster opening portion 380 is opened and closed by a defroster door 390 rotated around a rotary shaft 392.

A face opening portion 382 is formed on the upper wall portion of the air conditioning case 312 at a vehicle rear side of the defroster opening portion 380. Conditioned air from the air-mixing chamber 354 flows into the face opening portion 382 through the communication path 348, and is blown toward the head portion of a passenger in the passenger compartment from a face air outlet through a face duct. The face air outlet is provided on an upper portion of an instrument panel of the vehicle. The face opening portion 382 is opened and closed by a face door 394 rotated by a rotary shaft 396.

A front foot opening portion 356 is provided in a rear side wall of the air conditioning case 312, at an upper side thereof. Conditioned air from the air-mixing chamber 354 flows into the front foot opening portion 356 through the communication path 348. When the maximum heating mode is set, the warm air bypass inlet 360 is opened by the warm air bypass door 362, and air from the warm air bypass inlet 360 flows into the front foot opening portion 356 through the second warm air passage 358 while conditioned air from the air-mixing chamber 354 flows into the front foot opening portion 356. Air from the front foot opening portion 356 is blown toward the foot area of a passenger seated on a front seat in the passenger compartment from a front foot air outlet through a front foot duct. An inlet hole 356′ of the front foot opening portion 356 is opened and closed by a foot door 410 rotated by a rotary shaft 412.

A rear foot opening portion 384 is provided on the rear side wall of the air conditioning case 312, and is opposite to the warm air bypass inlet 360. Air from the warm air bypass inlet 360 and air from the second warm air passage 358 flow into the rear foot opening portion 384, and is blown toward the foot area of a passenger seated on a rear seat of the passenger compartment from a rear foot air outlet through a rear foot duct. In a two-layer airflow heating mode, the warm air bypass door 362 is rotated to positon B3 illustrated in FIG. 2 so that the air passage at an immediately downstream side of the heater core 322 is partitioned into the first and second air passages 80 and 82. The first and second air passages 80 and 82 are in communication with one another through the communication path 348 at a position proximate to an inlet of the defroster opening portion 380 and an inlet of the front foot opening portion 356. The defroster door 390, the face door 394, and the foot door 410 are operatively linked and rotated by any suitable actuator, such as a servomotor through a link mechanism, based on control signals from the control module 510 of the air conditioning system.

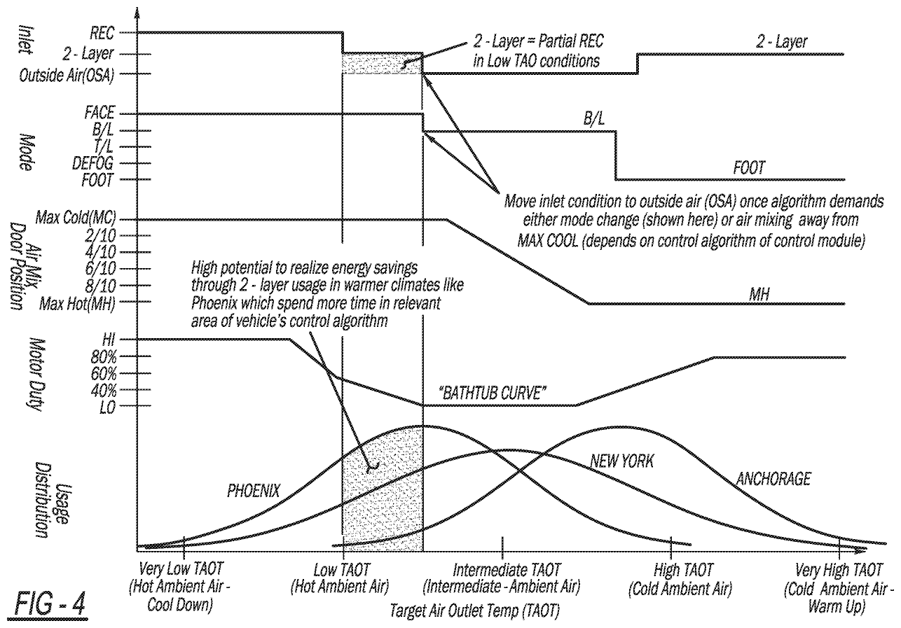

The control module 510 is further configured to operate the HVAC system in a two-layer airflow cooling mode in accordance with the present disclosure. In the exemplary control algorithm illustrated in FIG. 4 for the control module 510 of FIG. 3, the control module 510 is configured to operate the HVAC system in the two-layer airflow cooling mode when conditions call for maximum cold airflow and face airflow. To provide the two-layer airflow cooling mode, the control module 510 configures the blower unit 10 as illustrated in FIG. 1, which is the same manner as for the two-layer airflow heating mode. Specifically, the first inside/outside air switching door 20 is rotated to open the first inside air inlet port 12 to allow air from inside the passenger cabin to enter the blower unit 10 and be blow by the first fan 50 through the first air passage 80 and into the air conditioning unit 310. The second inside/outside air switching door 22 is rotated to close second inside air inlet port 14 and open outside air inlet port 16 to allow outside ambient air to flow into the blower unit 10 and be blown through the blower unit by the second fan 52 through the second air passage 82 and into the air conditioning unit 310.

In the two-layer airflow cooling mode, the control module 510 configures the air conditioning case 312 to provide maximum cooling out of the face opening portion 382. The inside air and the outside air flowing through the first and second air passages 80, 82 flows across the evaporator 320 and is cooled thereby. The control module 510 moves the first and second air-mixing doors 340, 342 to positions B1 and B2 respectively, which blocks the inside air and the outside air flowing through first and second air passages 80, 82 from flowing across, and being heated by, the heater core 322.

In the two-layer airflow cooling mode the control module 510 closes the foot door 410 to prevent airflow through the front foot opening portion 356, closes the warm air bypass door 362 to prevent airflow through the rear foot opening portion 384, and closes the defroster door 390. The control module 510 opens the face door 394 such that the inside air and the outside air flowing through first and second air passages 80, 82 and cooled by the evaporator 320 flows out through the face opening portion 382 to cool the passenger cabin. Prior to exiting the air conditioning case 312, the outside air and the inside air mixes in the air-mixing chamber 354 or prior to reaching the air-mixing chamber 354 in an area between the evaporator 320 and the air-mixing chamber 354.

With continued reference to FIG. 1 and FIG. 2, and additional reference to FIG. 3, the control module 510 will now be described further. In this application, including the definitions below, the term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the control module 510 described herein. In particular, the control module 510 is configured to operate the blower unit 10 and the air conditioning unit 310 to provide the modes of operation graphically illustrated in FIG. 4, particularly the two-layer airflow cooling mode.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

As illustrated in FIG. 3, signals are input to the control module 510 from a sensor group 512 and an operation group 514. The sensor group 512 includes various sensors 512A, 512B, 512C, 512D, and 512E. The operation group 514 includes various operation units 514A, 514B, 514C, 514D, and 514E.

The sensor group 512 includes: an inside air temperature sensor 512A configured to detect temperature of air inside the passenger cabin; an outside air temperature sensor 512B configured to detect temperature of air outside the passenger cabin; a sunlight volume sensor 512C configured to detect how much sunlight enters the vehicle; a water temperature sensor 512D configured to detect temperature of hot water flowing into the heater core 322, and an evaporator air temperature sensor 512E configured to detect air temperature at an air outlet of the evaporator 320.

The operation group 514 includes: an automatic air-conditioning control unit 514A configured to automatically control the temperature of air blown toward the passenger compartment; a temperature setting unit 514B configured for setting a target temperature of the passenger compartment; an air outlet mode setting unit 514C; an inside/outside air setting unit 514D; and an air volume setting unit 514E.

The various operation units 514A, 514B, 514C, 514D, and 514E are provided on an air-conditioning operation panel of the vehicle. The control module 510 is configured to perform calculation processes based on a pre-set program stored in the memory hardware (such as a program including the algorithm illustrated in FIG. 4) according to the input signals from the sensor group 512 and the operation group 514. The control module 510 outputs control signals to an electric driving motor 520 and actuator servomotors 522, 524, and 526. The servomotor 522 drives the first and second inside/outside air switching doors 20, 22 through a link mechanism. The servomotor 524 drives the first and second air-mixing doors 340, 342 and the warm air bypass door 362, which are operatively linked together. The servomotor 526 drives the defroster door 390, the face door 394, and the foot door 410, which are operatively linked together. The servomotor 524 drives the warm air bypass door 362 after rotating the first and second air-mixing doors 340, 342 to a predetermined position.

The control module 510 is configured to control the blower unit 10 and the air conditioning unit 310 to operate in various heating and cooling modes. Exemplary modes of operation are set forth in U.S. Pat. No. 6,135,201 titled “Air Conditioning Apparatus for Vehicle with Double Layer Flow Mode,” which issued on Oct. 24, 2000 and is assigned to DENSO Corporation of Kairya, Japan. The entire disclosure of U.S. Pat. No. 6,135,201 is incorporated herein by reference. With respect to the present disclosure, the control module 510 is further configured to control the blower unit 10 and the air conditioning unit 310 to operate the air conditioning system in the two-layer airflow cooling mode.

FIG. 4 graphically illustrates an exemplary control algorithm of the control module 510 for controlling the blower unit 10 and the air conditioning unit 310 in accordance with the present disclosure. As illustrated in FIG. 4, when the passenger cabin is very warm (and the ambient air is hot) the target air outlet temperature (TAOT) of the HVAC is set at its lowest temperature (designated in FIG. 4 as relatively “Very Low TAOT”) so as to provide maximum cooling to the passenger cabin. The control module 510 configures the blower unit 10 and the air conditioning unit 310 in a maximum cooling (MC) face mode blowing entirely recirculated passenger cabin air (i.e., no outside air is blown into the passenger cabin). To accomplish this and with respect to the blower unit 10, the control module 510 rotates the first inside/outside air switching door 20 to open the first inside air inlet port 12, and rotates the second inside/outside air switching door 22 to open the second inside air inlet port 14 and close the outside air inlet port 16. With respect to the air conditioning unit 310, the control module 510 restricts airflow from the blower unit 10 from being heated by the heater core 322 by moving doors 340 and 342 to positions B1 and B2 respectively to block airflow to the heater core 322. The control module also closes doors 362, 410, and 390 to restrict airflow out of the case 312 through the foot opening portions 356, 384 and the defroster opening portion 380. The control module opens the face door 394 to allow airflow cooled by the evaporator 320 to exit through face opening portion 382.

After the passenger cabin is cooled down a degree such that the TAOT of the HVAC is no longer at its lowest temperature, but is instead at a relatively “Low TAOT” as designated in FIG. 4, the control module 510 maintains the blower unit 10 and the air conditioning unit 310 in the maximum cooling (MC) face mode. But instead of blowing only recirculated air, the control module 510 configures the blower unit 10 in the two-layer airflow cooling mode by rotating the second inside/outside air switching door 22 to close the second inside air inlet port 14 and open the outside air inlet port 16. With the outside air inlet port 16 open, outside air is blown through the blower unit 10 into the air conditioning unit 310 where the outside air is cooled by the evaporator 320 and mixes with the recirculated inside air before exiting through the face opening portion 382.

The control module 510 is configured to maintain the blower unit 10 and the air conditioning unit 310 in the two-layer airflow cooling mode until any suitable predetermined condition is met, such as a mode change away from face mode to, for example, bi-level mode upon successful cooling of the passenger cabin, as illustrated in the exemplary algorithm of the control module 510 illustrated in FIG. 4. The control module 510 may also be configured to maintain the two-layer airflow cooling mode until maximum cooling is no longer called for, such as after the HVAC system has successfully reduced the temperature of the passenger cabin. After the TAOT has sufficiently increased (such as after the passenger cabin has been sufficiently cooled) so that the algorithm of the control module 510 no longer calls for face mode and the maximum cooling mode, the control module 510 operates the blower unit 10 and the air conditioning unit 310 in any suitable manner, such as illustrated in FIG. 4. For example, when heating is required the control module is configured to operate the blower unit 10 and the air conditioning unit 310 in the two-layer airflow heating mode, as described above and in U.S. Pat. No. 6,135,201 (the entire disclosure of which is incorporated by reference).

Thus, the control module 510 is configured to set the blower unit 10 and the air conditioning unit 310 in the two-layer cooling mode as long as the algorithm of the control module 510 calls for the HVAC system to operate in maximum cooling mode and face airflow only mode directing airflow only out of the face opening portion 382 to cool the passenger cabin, which advantageously prevents stratification issues during the two-layer cooling mode. This two-layer airflow cooling mode advantageously reduces energy consumption by way of compressor load reduction resulting from the blend of fresh and recirculated air (see reduction in “Motor Duty” in FIG. 4 when two-layer cooling mode is active). Use of the two-layer cooling mode to accomplish partial air recirculation advantageously avoids various shortcomings of previous systems, such as the “blow by” condition of fresh air blown directly into the vehicle in single door HVAC systems and driver alertness concerns that arise from overuse of recirculated air. As is evident from the control algorithm of the control module 510 illustrated in FIG. 4, energy savings are particularly significant when the HVAC system of the present disclosure is used in warmer climates because the control module 510 is configured to use the two-layer cooling mode most often in climates with relatively hot ambient air, such as Phoenix, Ariz. One skilled in the art will appreciate that the present disclosure provides numerous additional advantages as well.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A heating, ventilation, and air conditioning (HVAC) system for a cabin of a vehicle, the HVAC system comprising:
a blower unit including a first inside air inlet port, an outside air inlet port, and at least one airflow generating device configured to draw inside air from the cabin into the blower unit through the first inside air inlet port and draw outside air into the blower unit through the outside air inlet port;
an air conditioning unit in communication with the blower unit to receive the inside air and the outside air blown by the at least one airflow generating device, the air conditioning unit including an evaporator configured to cool the inside air and the outside air, and the air conditioning unit including a face opening portion through which the inside air and the outside air exits the air conditioning unit after being cooled, the face opening portion configured to be in communication with a face outlet of the cabin; and
a control module configured to operate the HVAC system in a two-layer airflow cooling mode by:
operating the blower unit to draw the inside air and the outside air into the blower unit and blow the inside air and the outside air through the blower unit into the air conditioning unit; and
operating the air conditioning unit to cool the inside air and the outside air, and direct the inside air and the outside air that has been cooled out of the air conditioning unit through only the face opening portion.

2. The HVAC system of claim 1, wherein:
the first inside air inlet port is configured to receive the inside air from a lower portion of the cabin;
the blower unit further includes a second inside air inlet port configured to receive the inside air from an upper portion of the cabin, and an inside/outside air switching door movable between the second inside air inlet port and the outside air inlet port; and
in the two-layer airflow cooling mode the control module is configured to control the inside/outside air switching door to close the second inside air inlet port and open the outside air inlet port.

3. The HVAC system of claim 1, wherein the at least one airflow generating device includes: a first fan configured to draw the inside air into the blower unit and blow the inside air into the air conditioning unit; and a second fan configured to draw the outside air into the blower unit and blow the outside air into the air conditioning unit.

4. The HVAC system of claim 1, wherein the air conditioning unit further includes:
a heater arranged on a downstream side of the evaporator; and
at least one air-mixing door between the evaporator and the heater, the at least one air-mixing door is movable between a first position and a second position, in the first position the at least one air-mixing door blocks the inside air and the outside air from flowing from the evaporator to the heater and directs the inside air and the outside air around the heater towards the face opening portion, in the second position the at least one air-mixing door allows the inside air and the outside air to flow to the heater;
wherein in the two-layer airflow cooling mode the control module is configured to move the at least one air-mixing door to the first position.

5. The HVAC system of claim 1, wherein the air conditioning unit further includes: a foot opening portion configured to be in communication with a foot airflow outlet of the cabin; and a foot door configured to open and close the foot opening portion;
wherein in the two-layer airflow cooling mode the control module is configured to position the foot door to close the foot opening portion.

6. The HVAC system of claim 5, wherein the foot opening portion is a front foot opening portion and the foot airflow outlet of the cabin is a front foot airflow outlet at a front of the cabin.

7. The HVAC system of claim 5, wherein the foot opening portion is a rear foot opening portion and the foot airflow outlet of the cabin is a rear foot airflow outlet at a rear of the cabin.

8. The HVAC system of claim 1, wherein the air conditioning unit further includes: a defroster opening portion configured to be in communication with a defrost outlet of the cabin; and a defroster door configured to open and close the defroster opening portion;
wherein in the two-layer airflow cooling mode the control module is configured to position the defroster door to close the defroster opening portion.

9. The HVAC system of claim 1, wherein the control module is configured to operate the HVAC system in the two-layer airflow cooling mode only during conditions under which the control module is configured to operate the air conditioning unit to generate maximum cooling and direct the inside air and the outside air that has been cooled out of the air conditioning unit through only the face opening portion.

10. A method for operating a heating, ventilation, and air conditioning (HVAC) system for a cabin of a vehicle, the method comprising:
operating a blower unit of the HVAC system in a two-layer airflow cooling mode with a control module of the HVAC system to draw inside air from the cabin into the blower unit through a first inside air inlet port, draw outside air into the blower unit through an outside air inlet port, and blow the inside air and the outside air through the blower unit into an air conditioning unit of the HVAC system; and
operating the air conditioning unit in the two-layer airflow cooling mode with the control module to cool the inside air and the outside air with an evaporator, and direct the inside air and the outside air that has been cooled out of the air conditioning unit through only a face opening portion configured to be in communication with a face outlet of the cabin.

11. The method of claim 10, further comprising controlling with the control module an inside/outside air switching door of the blower unit to close a second inside air inlet port and open the outside air inlet port, the first inside air inlet port is configured to receive the inside air from a lower portion of the cabin and the second inside air inlet port is configured to receive the inside air from an upper portion of the cabin.

12. The method of claim 10, wherein operating the blower unit in the two-layer airflow cooling mode includes activating at least one airflow generating device of the blower unit.

13. The method of claim 10, wherein operating the blower unit in the two-layer airflow cooling mode includes: activating a first fan configured to draw the inside air into the blower unit and blow the inside air into the air conditioning unit; and activating a second fan configured to draw the outside air into the blower unit and blow the outside air into the air conditioning unit.

14. The method of claim 10, wherein operating the air conditioning unit in the two-layer airflow cooling mode includes positioning at least one air-mixing door to block the inside air and the outside air from flowing from the evaporator to a heater, and to direct the inside air and the outside air around the heater towards the face opening portion.

15. The method of claim 10, wherein operating the air conditioning unit in the two-layer airflow cooling mode includes positioning a foot door to close a foot opening portion configured to be in communication with a foot outlet of the cabin.

16. The method of claim 15, wherein the foot opening portion is a front foot opening portion and the foot outlet of the cabin is a front foot outlet at a front of the cabin.

17. The method of claim 15, wherein the foot opening portion is a rear foot opening portion and the foot outlet of the cabin is a rear foot outlet at a rear of the cabin.

18. The method of claim 10, wherein operating the air conditioning unit in the two-layer airflow cooling mode includes positioning a defroster door to close a defroster opening portion of the air conditioning unit configured to be in communication with a defrost outlet of the cabin.

19. The method of claim 10, further comprising operating the blower unit and the air conditioning unit in the two-layer airflow cooling mode only during conditions under which the control module is configured to operate the air conditioning unit to generate maximum cooling and direct the inside air and the outside air that has been cooled out of the air conditioning unit though only the face opening portion.

20. The method of claim 10, further comprising:
operating the blower unit of the HVAC system in a two-layer airflow heating mode with the control module to draw inside air from the cabin into the blower unit through the first inside air inlet port, draw outside air into the blower unit through the outside air inlet port, and blow the inside air and the outside air through the blower unit into an air conditioning unit of the HVAC system; and
operating the air conditioning unit in the two-layer airflow heating mode with the control module to heat the inside air and the outside air with a heater, and direct the inside air and the outside air that has been heated out of the air conditioning unit through only one or more foot opening portions configured to be in communication with one or more foot outlets of the cabin.
